(19) United States
(12) Patent Application Publication
(10) Pub. No.: US 2009/0282652 A1
(43) Pub. Date: Nov. 19, 2009

(54) CHILD SAFE DOOR KNOB

(76) Inventor: Tagarira Maramba, Malton (CA)

Correspondence Address: NASSER ASHGRIZ, 7805 Bayview Ave., # 1510, Thornhill, ON, L3T 7N1, CA

(21) Appl. No.: 12/120,805

(22) Filed: May 15, 2008

(51) Int. Cl. E05B 1/00

(52) U.S. Cl. 16/441

(57) ABSTRACT

Child safe door knob having an inner knob that can freely rotate without opening the door. The inner knob adapted to be rotably and slidably mounted to an inner side of a door. The outer door knob being connected to a first end of a spindle, wherein said spindle being connected to a latch and a lock mechanism. The second end of said spindle not being engaged with the inner door knob under the normal conditions. The inner door knob becomes engaged with the spindle when aligned with the spindle and pushed in.

### FIELD OF THE INVENTION

The present invention relates to door knobs with child safety mechanism. The object of the present invention is to make it difficult for children to open an unlocked door. The present door knob mechanism can be implemented on any door knob, door lock, kitchen and medicine cabinet knobs or other places in which a knob is used.

### BACKGROUND OF THE INVENTION

A large variety of door knobs have been disclosed in the prior art. A door using any of the disclosed door knobs can be opened by turning the door knob. In order to prevent children from opening the door, the door is either locked (using key or other locking mechanisms) or some other child safety features are added to the lock. In most instances, particularly for the interior doors and high traffic zones of a dwelling, the door is usually not locked. However, there may be a need to prevent children from opening such unlocked doors. Currently there are no knobs that have such a function.

Generally, a door is locked to prevent children from opening it. There are a large variety of door knobs with locks. Some locks need a key to open the door. Some have a turning button on the inner door knob, which is rotated to lock the door from the inside. To unlock the door, first the button has to be rotated back and then the inner door knob can be rotated to open the door. Some use push button or push and turn button to lock the door, or push and turn the whole door knob to lock the door. These locks allow for quick unlock by simply turning the knob.

Although a door can be locked to prevent children from opening it, continuous locking and unlocking of an interior door or a door in a high traffic area is not preferred. Adult may even forget to lock a door. In addition, because of the safety issues, it is not advisable to keep all doors locked. For instance, in the case of fire and other emergencies, there may be an urgent need to leave the room.

There are also external attachments to the door or the door knob for child safety. However, such extra attachments are as inconvenient as a door lock, if not more, and they change the appearance of the door and door knobs.

Therefore, it is preferred to keep the doors unlocked from the inside and have a simple and convenient child safety feature on the knob to prevent the children from opening the door. It is the object of the present invention to have a door knob that does not need to be locked, yet it is difficult for a child to open it. The disclosed invention is not a locking mechanism, but it is a child safety mechanism that can be implemented in any conventional door knob.

The present invention is based on a press and rotate mechanism to open the door. This should be distinguished from the press and rotate mechanism for locking a door. The present invention makes it difficult for a child to open the door, since two functions, press and rotate, have to be done together in order to open the door. In addition, knob alignment mechanisms for opening can be implemented in order to make it even more difficult for children to open the door. Children, very quickly learn how to turn a door knob. The present invention allows a child to freely turn the door knob without opening the door. The especially designed mechanism allows the inner door knob to spin freely. Adults do not have to worry about locking a door (if not needed except for child safety) any more. Thereby, allowing adults for a quick and easy access to restricted areas. The present invention can be added to any door lock mechanism. Apart from that, the mechanism consists of a traditional rotary type knob and lock where a door knob is rotated to unlatch a bolt.

### SUMMARY OF THE INVENTION

Accordingly, it is an object of the present invention to provide safe and secure child protecting mechanism to prevent young children from opening unlocked doors, while allowing adults quick and easy opening mechanism. In view of the disadvantages of the conventional door knobs with locks, the present invention describes a new door knob which does not allow children to easily open the door by turning the knob. The door knob in the present invention comprises of an outer knob, an inner knob, and an inner latch and lock mechanism which can become engaged or disengaged from the inner door knob.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is an exploded and perspective view of main parts of both inside and outside of a spring loaded door knob and illustrates the manner in which the parts are assembled.

FIG. 2 is a perspective view of a spring loaded door knob assembled.

FIG. 3 is a cross sectional view of the door knob illustrating the spindle and the engagement method of the inner door knob. The door knob is not engage in the present illustration.

FIG. 4 is an exploded and perspective view of main parts of both inside and outside of a magnetically loaded door knob and illustrates the manner in which the parts are assembled.

FIG. 5 is a perspective view of a magnetically loaded door knob as assembled

FIG. 6 is a magnetically loaded door knob with external magnets illustrating the location of the magnets as well as the alignment lines to align the door knob with the spindle using the press-and-engage mechanism.

FIG. 7 is the cross sectional view of FIG. 6, showing the internal engagement mechanism.

FIG. 8 is a perspective view of a spring plus magnetically loaded door knob.

FIG. 9 is a cross sectional view of a spring loaded cabinet knob with a lever.

### DETAILED DESCRIPTION

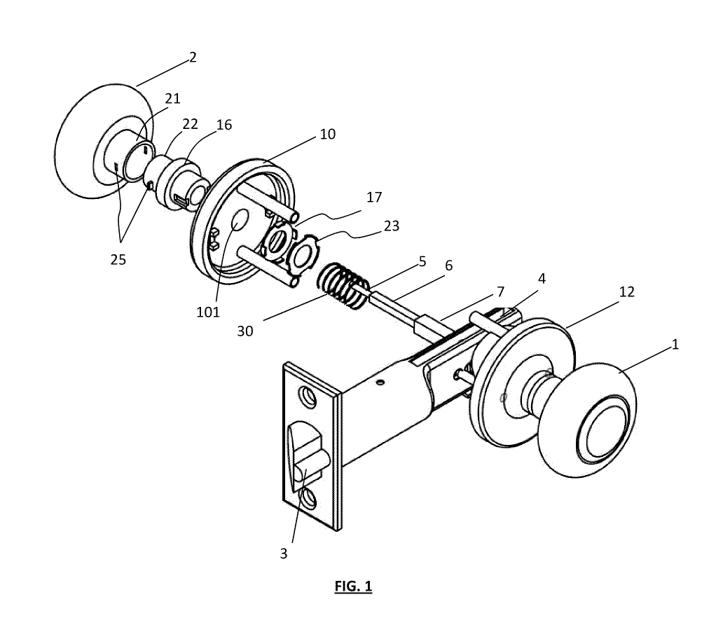

An exemplary embodiment of a door knob in accordance with the present invention, as shown in FIG. 1, comprises an outer knob 1, an inner knob 2 and an inner mechanism which is connected to the outer door knob, but not engaged to the inner door knob on the normal conditions. Turning of the outer door knob withdraws the door latch 3 by turning a control mechanism at connection point 4, allowing the door to be opened. The inner door knob will only engage with the inner connecting mechanism if it is pushed inward. Under the normal conditions, when the inner door knob is not engage, it can freely rotate without moving the latch. The inner door knob can withdraw the latch only when it is pushed in.

The inner and outer door knobs are commonly mounted on an axle, called a spindle, 5, 6, 7, which has at least one flat side. The spindle which extends through the door latch has some length exposed on each side of the door to which the knobs are attached. The spindle also cooperates with the door latch at 4 such that when either knob is turned, the spindle is tuned with it, and the resultant turning withdraws the latch. In many of the door knobs with a lock mechanism, the door knob can be disengages from the spindle by a clutch mechanism using a locking key. Only a key can re-engage the knob to the spindle. There are many other locking mechanisms that prevent the turning motion of the spindle when locked The present invention can be used with any of the door knob and door lock mechanisms that use a spindle. Therefore, detailed descriptions of the locking mechanisms are not provided here.

The present invention relates to the inner door knob and its engagement to the spindle. In its basic embodiment, the inner door knob in the present invention is not engages with the spindle under the normal conditions. A simple engagement mechanism is provided, which does not require any locking mechanism or a key. The engagement is achieved by simply pushing the door knob inward. In its normal condition, the door knob is push outward by a spring or a set of magnets situated inside or outside of the door knob mechanism.

The structural characteristics, features and other advantages of the present invention can be best described in detail through showing preferred embodiment thereof in conjunction with the accompanying drawings as follows:

FIGS. 1-3 show a spring loaded child protecting mechanism comprising of an outer door knob 1 which includes a protective cover 12 mounted to an outer side of a door. Outer door knob works the same way and has the same structure and features as a conventional door knob, details of which are not provided here.

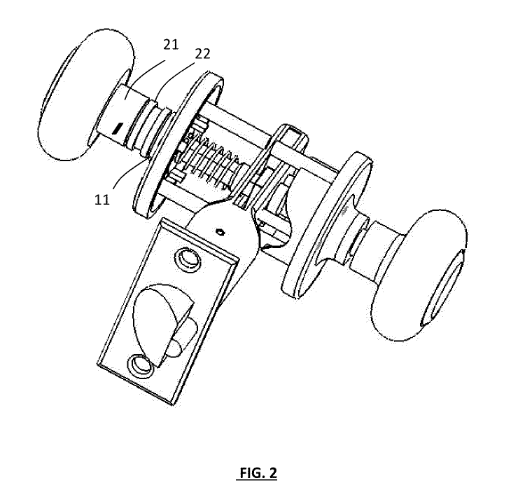

The inner door knob has two main pads. A protective cover 10, which is mounted to the inner side of a door, and a door knob 2. The inner door knob 2 is an axially slidable door knob, which can not only turn or spin, but move or slide in and out. The protective cover plate 10 has an aperture through which the movable part of the door knob can slide in and out. The inner door knob can be secured to the protective cover using a bearing mechanism, which allows for both angular and axial movements. The slidable knob 2 comprises of at least two sleeves, 21 and 22. Sleeve 22 has a smaller diameter than sleeve 21. Sleeve 22 is received by the cover plate 10. Sleeve 22 having a first end attached to inner sleeve 21 and the second end attached to an end plate 23 to prevent the disengagement of the inner door knob 2 from the protective cover 10. The connection mechanism of slidable knob 22 to the end plate 23 is conventional and therefore not described further. Sections 2, 21, 22 and 23 can be separate parts joined to each other or made of one piece. Door knob 2 can be pushed a distance 25 between section 21 and 11, as shown in FIG. 2. A section of the inner knob 23, which is connected to the movable part of the inner knob, 22, can receive one end of a compression spring 30. The spindle connected to the outer door knob 1 has three sections The end section 5 has a circular cross section, the middle section, 6 has a noncircular cross section or a at least one flat side, like a semicircular cross section with a flat side, and the third section 7 has a larger cross section than the middle side and also has at least one flat side. The cross section of the middle part 6 can be any non-circular shape, for instance, it can be triangular, rectangular, hexagonal and elliptical.

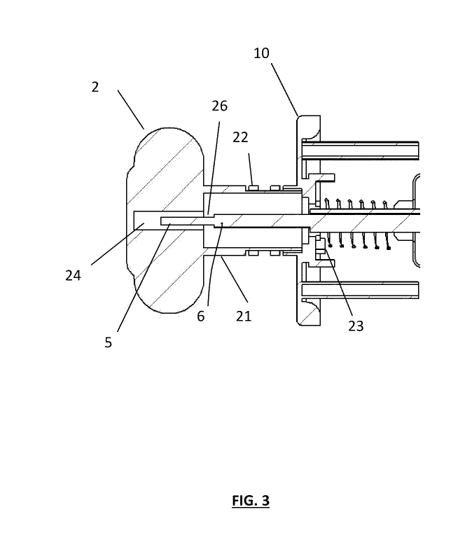

The cross sectional view of the inner door knob is shown in FIG. 3. Inner door knob has an opening or a receptacle 24 which receives the spindle. The opening 24 has the same cross sectional shape as that of the middle part of the spindle, 6. The first section of the spindle, 5, goes through the opening 24 and it is slightly smaller than that of the inner door knob opening. Therefore, the inner door knob can spin around 5 without engaging with the spindle. The inner door knob only engages with the spindle if it is pushed in at least a small distance shown as 26 in FIG. 3, so that it engages with the non-circular part of the spindle 6. The third section 7 engages with the latch mechanism at 4 to withdraw the latch when either of the door knobs is turned.

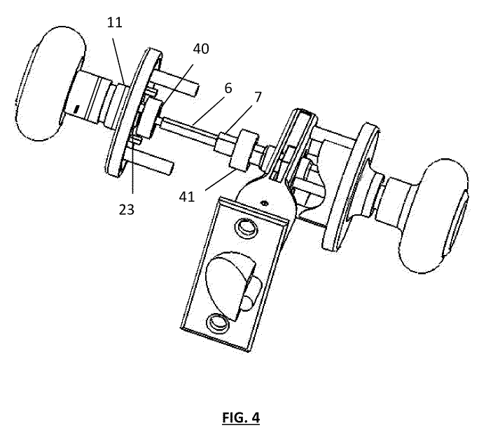

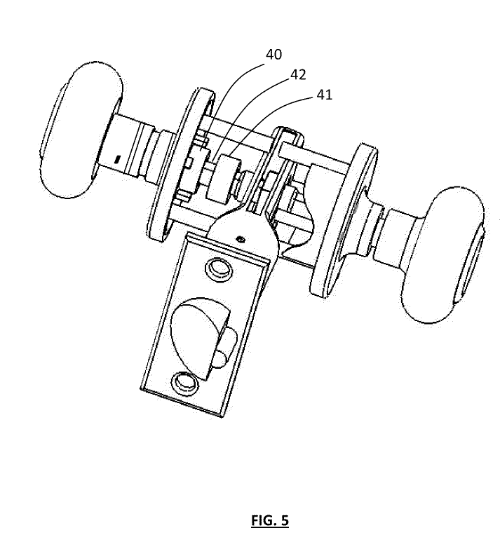

In another embodiment of the same invention, magnets, instead of a spring, are used to prevent the engagement of the inner door knob with the spindle, as shown in FIGS. 4 and 5. One magnet 40 is attached to the end of the inner part of the inner knob 23, and the other magnet 41 is set on the spindle. Magnet 41 has an aperture which has the same cross sectional shape as that of the spindle part 7. The magnets are installed such that they provide a repelling force between them. Under the normal conditions, the repelling force keeps the inner door knob disengaged from the spindle. The inner knob will only engage with the spindle if enough force is applied to the knob to overcome the repelling magnetic force. FIG. 5 shows the assembled door knob, in which there is a gap 42 between the two magnets 40 and 41. This gab is at least the same or more than the distance needed to push the door knob to engage it with the spindle shown as 26 in FIG. 3.

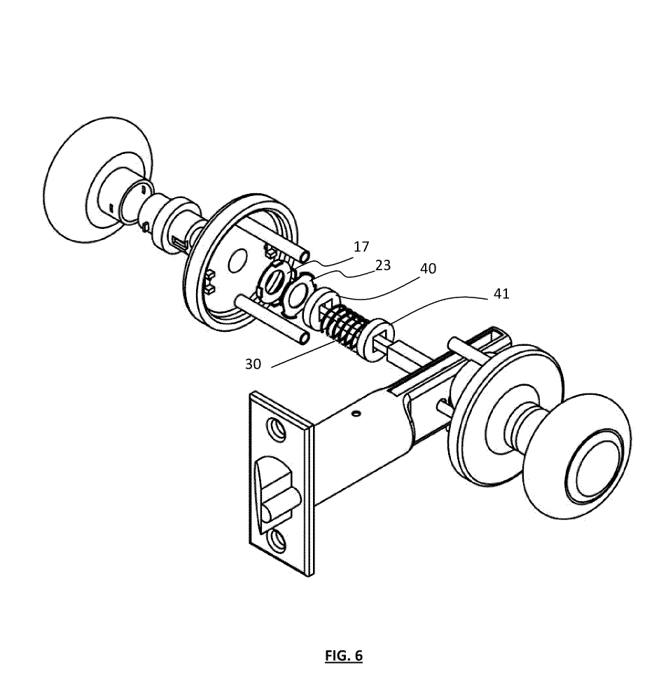

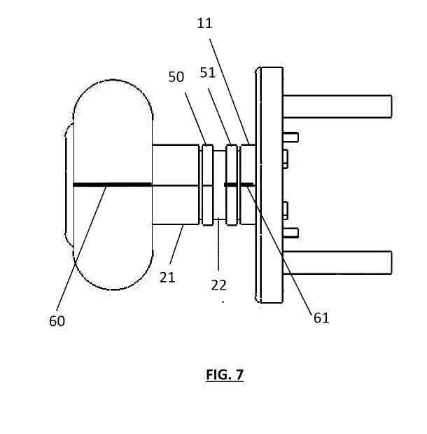

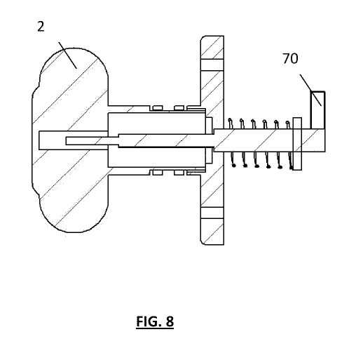

The two repelling magnets can be located at different parts of the door knob. For instance, FIGS. 6 and 7 show another embodiment of the same invention, in which the magnets are located on the door knob itself. One magnet 50 is connected to the slidable part of the inner knob, 21 and 22 and the other magnet 51 is connected to the fixed part of the inner door knob 11 The magnets are installed such that they provide a repelling force between them. Under the normal conditions, the repelling force keeps the inner door knob disengaged from the spindle. The inner knob will only engage with the spindle if enough force is applied to the knob to overcome the repelling magnetic force.

The inner door knob has to be pushed in, overcoming the magnetic force, as well as be aligned to engage with the spindle. Achieving these two tasks simultaneously is difficult for young children. In order to simplify the alignment of the door knob with the spindle certain alignment lines or arrows can be put on the slidable and fixed parts of the door knob as shown in FIG. 6 with alignment lines 60 and 61.

The present mechanism can be used on any knob or lock. For instance, it can be used in knobs used in kitchen, bathroom and medicine cabinets to prevent children from opening them. A kitchen cabinet knob, as exemplified in FIG. 9, is simply made of a small lever, 70, which is turned to open the door. The lever can be disengaged from the knob, 2, using the same mechanism disclosed here Therefore, the knob can freely turn without turning the lever.

In most door knobs, the outer door knob has a lock mechanism incorporated therein. The door knob can be locked, preventing its turning movement, and it can be unlocked using a key mechanism. Similar locking mechanism can be incorporated in the inner door knob as well, preventing the turning of the door knobs.

1. (canceled)

2. (canceled)

3. (canceled)

4. (canceled)

5. A child safe door knob comprising:
a. an outer door knob adapted to be rotably mounted to the outside of a door;
b. connecting means to connect said outer door knob to a spindle;
c. connecting means to connect said spindle to a door latch mechanism;
d. an inner slidable door knob having a longitudinal central axis adapted to be rotably and slidably mounted to an inner side of the door by means of an inner protective cover;
e. said inner door knob having an inner cavity along said central axis, said cavity having a non-circular cross section;
f. said inner door knob having means to keep said slidable door knob away from the spindle, whereby said slidable inner door knob is not engaged to the spindle extending from the outer door knob and spins freely;
g. said spindle comprising:
a first distal section of substantially circular cross section having a diameter smaller than the smallest diameter of the inner door knob cavity, whereby the inner knob spins on said first section without becoming engaged with the spindle;
a second section adjacent to the first section having a non circular cross section of substantially the same shape as the cross section of said cavity to which the inner door knob engages;
a third section to engage with the latch mechanism;
h. said inner door knob having means to align the slidable door knob with the spindle in order to allow the inner door knob to be received by the spindle,
whereby said inner door knob engages with said spindle by first aligning the slidable door knob with the spindle and then pushing said inner door knob towards said spindle, whereby allowing for the door to be opened by turning the inner slidable door knob.

6. A door knob according to claim 5, whereas the inner slidable door knob is kept disengaged from the spindle by a compression spring, wherein said spring coaxially mounted on the spindle; one end of said spring held against the door latch and the other end held against the slidable door knob, whereby said inner door knob engages with the spindle by overcoming the spring force by pushing the inner door knob inward towards the door.

7. A door knob according to claim 5, whereas the inner slidable door knob is kept disengaged from the spindle by a set of opposing magnets, wherein one magnet attached to the slidable door knob and the other magnet coaxially mounted on the spindle, whereby the distance between said magnets is small enough to result in a repelling force once the door knob is pushed inwards, and whereby said inner door knob engages with the spindle by overcoming the magnetic force by pushing the inner door knob inward towards the door.

8. A door knob according to claim 6, further comprising a set of magnets to keep the spindle disengaged from the inner slidable door knob, wherein one magnet attached to the slidable door knob and the other magnet coaxially mounted on the spindle, whereby the distance between said magnets is small enough to results in a repelling force once the door knob is pushed inwards, and whereby said inner door knob engages with the spindle by overcoming the spring and magnet forces by pushing the inner door knob inward towards the door.

9. (canceled)

10. A child safe cabinet knob for a cabinet, door comprising:
a. a knob,
b. connecting means to connect said knob to a spindle;
c. connecting means to connect said spindle to a cabinet latch;
d. said knob comprising of a slidable knob and means to keep said slidable knob away from the spindle;
e. said knob having a non-circular longitudinal axial cavity;
f. said spindle comprising:
a first section having a cross sectional diameter smaller than the smallest diameter of said cavity, whereby the knob spins on said first section without becoming engaged with the spindle;
a second knob receivable section having a non circular cross section of substantially the same cross sectional shape as the cross section of said cavity to which the knob engages;
a third section to engage with the cabinet latch;
g. said knob having means to align the knob with the spindle in order to allow the knob to be received by the spindle.
whereby said slidable knob is not engaged to the spindle in a normal setting, and said knob will engage with said spindle upon pushing said knob inwards towards the cabinet, whereby said latch can be turned to open the cabinet door.

11. A knob according to claim 10, whereas said knob is kept disengaged from the spindle by a compression spring, wherein said spring coaxially mounted on the spindle, one end of said spring held against the door latch and the other end held against the slidable knob, whereby said knob engages with the spindle by overcoming the spring force by pushing the knob inwards towards the cabinet.

12. A knob according to claim 10, whereas said knob is kept disengaged from the spindle by a set of opposing magnets, wherein one magnet attached to the slidable door knob and the other magnet coaxially mounted on the spindle, whereby the distance between said magnets is small enough to result in a repelling force once the door knob is pushed inwards, whereby the knob engages with the spindle by overcoming the magnetic force by pushing the knob inward towards the cabinet.

13. A knob according to claim 11, further comprising a set of magnets to keep the spindle disengaged from the inner slidable door knob, wherein one magnet attached to the slidable knob and the other magnet coaxially mounted on the spindle, whereby the distance between said magnets is small enough to result in repelling force once the doorknob is pushed inwards, whereby said knob engages with the spindle by overcoming the spring and magnetic forces by pushing the knob inward towards the cabinet.
